(19) United States
(12) Patent Application Publication
(10) Pub. No.: US 2026/0149905 A1
(43) Pub. Date: May 28, 2026

(54) FLOATING CUP HOLDER WITH LOUDSPEAKER

(71) Applicant: Zhejiang Mambobaby Baby Products Co., Ltd., Jinhua (CN)

(72) Inventors: LIFANG GUO, Jinhua (CN); WEIXIN ZHOU, Jinhua (CN)

(21) Appl. No.: 19/001,576

(22) Filed: Dec. 26, 2024

(30) Foreign Application Priority Data
Nov. 27, 2024 (CN) 202422898550.1

(51) Int. Cl. H04R 1/02; A47G 23/02

(52) U.S. Cl. CPC H04R 1/028; A47G 23/0216; A47G 2200/02; H04R 2420/07

(57) ABSTRACT

A floating cup holder with loudspeaker is disclosed, including a Bluetooth loudspeaker and a cup holder. The center of the Bluetooth loudspeaker is provided with a cup holder. By arranging a cup holder at the center of the Bluetooth loudspeaker, beverage cups can be placed on the cup holder. The bottom of the cup holder is recessed to prevent the cup from tipping over easily, meeting people's drinking needs; the foldable design of the cup holder makes it convenient for daily carrying.

### CROSS-REFERENCE TO RELATED APPLICATIONS

This application claims priority to Chinese Patent Application No. 202422898550.1, filed on Nov. 27, 2024, which is hereby incorporated by reference in its entirety.

### TECHNICAL FIELD

The present disclosure relates to the technical field of cup holders, particularly to the technical field of a floating cup holder with loudspeaker.

### BACKGROUND

Patent document with publication number CN209448884U discloses a floating loudspeaker. This floating loudspeaker has a cavity structure with a hollow interior and significant buoyancy, allowing the entire loudspeaker to float on water. During swimming or pool parties, people have a need to drink in the water, and this floating loudspeaker cannot meet their drinking needs.

### SUMMARY

The purpose of the present disclosure is to address the problems found in existing technology by proposing a floating cup holder with loudspeaker that can solve the above issues.

To achieve the above purpose, the present disclosure proposes a floating cup holder with loudspeaker, which includes a Bluetooth loudspeaker and a cup holder, with the center of the Bluetooth loudspeaker being provided with the cup holder.

Preferably, the cup holder is fixedly installed with the Bluetooth loudspeaker.

In other embodiments, the cup holder is detachably installed with the Bluetooth loudspeaker.

Preferably, the bottom of the cup holder is provided with a water inlet hole.

Preferably, the cup holder is of a foldable structure.

Preferably, multiple through holes are distributed on the Bluetooth loudspeaker, and more than one cup holder is provided.

Preferably, the Bluetooth loudspeaker is uniformly equipped with multiple sound outlets in a loop.

Preferably, the Bluetooth loudspeaker includes a floating shell, a cavity structure is arranged in the floating shell, a circuit board and a speaker are arranged in the cavity structure, a Bluetooth module is arranged on the circuit board, and the speaker is arranged on an inner side of a sound outlet.

Preferably, the outer side of the Bluetooth loudspeaker is provided with a slope.

Preferably, the bottom of the Bluetooth loudspeaker is provided with a foldable support.

Preferably, the bottom of the Bluetooth loudspeaker is provided with a magnet.

The magnet allows the Bluetooth loudspeaker to adhere to metal objects such as metal tables, walls, cars, shower products, etc.

The beneficial effects of the present disclosure are as follows. By arranging a cup holder at the center of the Bluetooth loudspeaker, a beverage cup can be placed on the cup holder. The bottom of the cup holder is recessed to prevent the cup from tipping over easily, meeting people's drinking needs; the foldable design of the cup holder makes it convenient for daily carrying; water can enter through the water inlet hole at the bottom of the cup holder to cool the beverage; the magnet at the bottom allows the Bluetooth loudspeaker to adhere to metal objects such as metal tables, walls, cars, shower products, etc.; the through holes facilitate gripping and can be used to tie ropes, ribbons and other connectors.

The features and advantages of the present disclosure will be explained in detail through the embodiments combined with the drawings.

### BRIEF DESCRIPTION OF DRAWINGS

FIG. 1 is a top view of the present disclosure;

FIG. 2 is a side view of the present disclosure.

In the figures: 1. Floating shell; 2. Bluetooth loudspeaker; 3. Cup holder; 4. Sound outlet; 6. Through hole; 7. Slope; 8. Guide groove.

### DESCRIPTION OF EMBODIMENTS

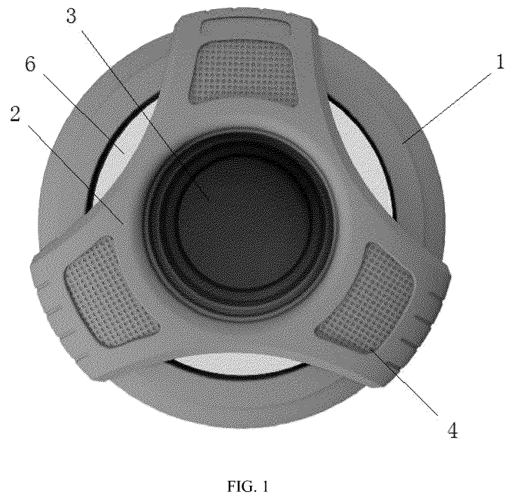

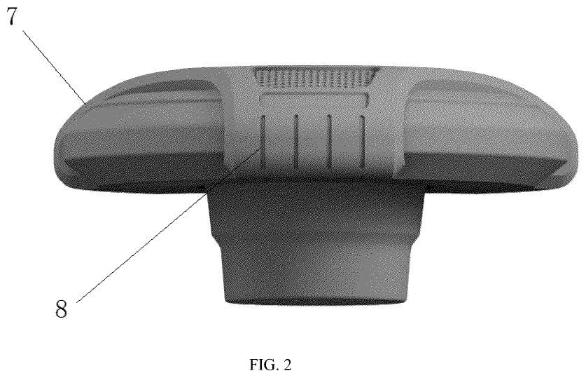

Referring to FIG. 1 and FIG. 2, the floating cup holder with loudspeaker includes a Bluetooth loudspeaker 2 and a cup holder 3. The Bluetooth loudspeaker 2 is annular, with a cup holder 3 located at its center; the cup holder 3 is fixedly installed with the Bluetooth loudspeaker 2; the bottom of the cup holder 3 is provided with a water inlet hole; the cup holder 3 is of a foldable structure, protruding towards the bottom of the Bluetooth loudspeaker 2 when unfolded, and lower than or parallel to the bottom of the Bluetooth loudspeaker 2 when folded; the Bluetooth loudspeaker 2 is uniformly equipped with multiple sound outlets 4 in a loop; the Bluetooth loudspeaker 2 is provided with evenly distributed through holes 6; the Bluetooth loudspeaker 2 includes a floating shell 1, a cavity structure is arranged in the floating shell 1, a circuit board and a speaker are arranged in the cavity structure, the interior of the cavity structure is balanced by a counterweight, a Bluetooth module is arranged on the circuit board, and the speaker is arranged on an inner side of sound outlets 4; the outer side of the Bluetooth loudspeaker 2 is provided with a slope 7, with guide grooves 8 on the sloped 7, the bottom of the Bluetooth loudspeaker 2 is provided with a foldable support; the bottom of the Bluetooth loudspeaker 2 is provided with a magnet.

In other embodiments, the cup holder 3 is detachably installed with the Bluetooth loudspeaker 2.

The above embodiments are explanations of the present disclosure and not limitations thereof. Any simple transformation schemes of the present disclosure fall within the scope of protection of the present disclosure.

What is claimed is:

1. A floating cup holder with loudspeaker, comprising a Bluetooth loudspeaker (2) and a cup holder (3), wherein a center of the Bluetooth loudspeaker (2) is provided with the cup holder (3).

2. The floating cup holder with loudspeaker as claimed in claim 1, wherein the cup holder (3) is detachably installed with the Bluetooth loudspeaker (2).

3. The floating cup holder with loudspeaker as claimed in claim 1, wherein the cup holder (3) is fixedly installed with the Bluetooth loudspeaker (2).

4. The floating cup holder with loudspeaker as claimed in claim 1, wherein a bottom of the cup holder (3) is provided with a water inlet hole.

5. The floating cup holder with loudspeaker as claimed in claim 1, wherein the cup holder (3) is of a foldable structure.

6. The floating cup holder with loudspeaker as claimed in claim 1, wherein a plurality of through holes (6) are distributed on the Bluetooth loudspeaker (2), and more than one cup holder (3) is provided.

7. The floating cup holder with loudspeaker as claimed in claim 1, wherein the Bluetooth loudspeaker (2) comprises a floating shell (1), a cavity structure is arranged in the floating shell (1), a circuit board and a speaker are arranged in the cavity structure, a Bluetooth module is arranged on the circuit board, and the speaker is arranged on an inner side of a sound outlet (4).

8. The floating cup holder with loudspeaker as claimed in claim 1, wherein an outer side of the Bluetooth loudspeaker (2) is provided with a slope (7).

9. The floating cup holder with loudspeaker as claimed in claim 1, wherein the bottom of the Bluetooth loudspeaker (2) is provided with a foldable support.

10. The floating cup holder with loudspeaker as claimed in claim 1, wherein the bottom of the Bluetooth loudspeaker (2) is provided with a magnet.
